(19) United States
(12) Patent Application Publication
(10) Pub. No.: US 2018/0159318 A1
(43) Pub. Date: Jun. 7, 2018

(54) Power Rail Clamp Circuit

(71) Applicant: NOVATEK Microelectronics Corp., Hsin-Chu (TW)

(72) Inventors: Jie-Ting Chen, Yilan County (TW); Chun-Yu Lin, Hsinchu City (TW); Ming-Dou Ker, Hsinchu County (TW); Ju-Lin Huang, Hsinchu County (TW); Tzu-Chiang Lin, Hsinchu City (TW); Tzu-Chien Tzeng, Hsinchu City (TW)

(21) Appl. No.: 15/372,363

(22) Filed: Dec. 7, 2016

(51) Int. Cl. H02H 9/04; H02H 1/04

(52) U.S. Cl. CPC H02H 9/04; H02H 1/04

(57) ABSTRACT

A power rail clamp circuit is coupled between a system power supply and a ground for alleviating an electrostatic discharge effect. The power rail clamp circuit includes a first conduction circuit, a second conduction circuit, an AND gate module and a switch module. The AND gate module receives a first conduction signal generated by the first conduction circuit and a second conduction signal generated by the second conduction circuit to generate an enabling signal. The switch module conducts the power rail clamp circuit according to the enabling signal, to process an electrostatic discharge operation. The first conduction circuit is operated to prevent a high voltage value of the system power supply, and the second conduction circuit is operated to prevent a short initiation period of the system power supply.

### BACKGROUND OF THE INVENTION

### 1. Field of the Invention

The present invention relates to a power rail clamp circuit, and more particularly, to a power rail clamp circuit which is operated to simultaneously prevent a high voltage value and a short initiation period of a system power supply without being erroneously triggered.

### 2. Description of the Prior Art

While electronic devices are rapidly scaled down, the electrostatic discharge (ESD) effect significantly dominates the performance of the electronic devices. Accordingly, an ESD power rail clamp circuit is provided to prevent the ESD effect. There are two conventional schemes of the ESD power rail clamp circuit; one is the RC-based power rail clamp circuit and the other is the diode string power rail clamp circuit. However, the RC-based power rail clamp circuit is easily affected by a short initiation period of a system power supply, and the diode string power rail clamp circuit has a leakage disadvantage while operating in a normal mode.

Therefore, it has been an important issue to provide an improved power rail clamp circuit to be operated in a scenario as supplying the high voltage value and the short initiation period of the system power supply without being erroneously triggered.

### SUMMARY OF THE INVENTION

It is the object of the invention to provide a power rail clamp circuit which is operated to simultaneously prevent a high voltage value and a short initiation period of a system power supply without being erroneously triggered.

In order to alleviate the ESD effect, an aspect of the present invention provides a power rail clamp circuit coupled between a system power supply and a ground. The power rail clamp circuit comprises a first conduction circuit, a second conduction circuit, an AND gate module and a switch module. The first conduction circuit is coupled to the system power supply, and is configured to generate a first conduction signal. The second conduction circuit is coupled to the system power supply, and is configured to generate a second conduction signal. The AND gate module is coupled to the system power supply, the first conduction circuit and the second conduction circuit, and is configured to receive the first conduction signal and the second conduction signal for generating an enabling signal. The switch module is coupled to the system voltage source and the AND gate module, and is configured to conduct the power rail clamp circuit according to the enabling signal for processing an electrostatic discharge operation. The first conduction circuit is operated to prevent a high voltage value of the system power supply, and the second conduction circuit is operated to prevent a short initiation period of the system power supply.

With the power rail clamp circuit, the present invention prevents a high voltage value of the system power supply and a short initiation period of the system power supply, so as to alleviate the ESD effect without being erroneously triggered or generating leakages.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a power rail clamp circuit according to an embodiment of the present invention.

FIG. 2 illustrates a schematic diagram of a detailed power rail clamp circuit according to an embodiment of the present invention.

FIG. 3 to FIG. 6 illustrate schematic diagrams of different realizations of power rail clamp circuits according to embodiments of the present invention.

FIG. 7 illustrates another schematic diagram of a power rail clamp circuits according to an embodiment of the present invention.

FIG. 8 to FIG. 10 illustrate schematic diagrams of experimental results of a power rail clamp circuit according to an embodiment of the present invention.

FIG. 11 illustrates a schematic diagram of a realization of a power rail clamp circuit according to an embodiment of the present invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

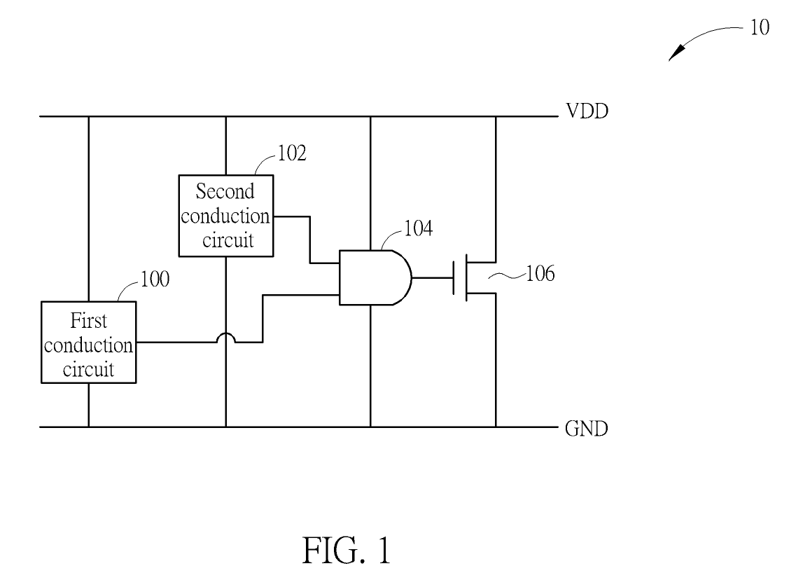

Please refer to FIG. 1, which illustrates a schematic diagram of a power rail clamp circuit 10 according to an embodiment of the present invention. As shown in FIG. 1, the power rail clamp circuit 10 is coupled between a system power supply VDD and a ground GND, and comprises a first conduction circuit 100, a second conduction circuit 102, an AND gate module 104 and a switch module 106. In detail, the system power supply VDD is a voltage source to supply the first conduction circuit 100, the second conduction circuit 102, the AND gate module 104 and the switch module 106. The first conduction circuit 100 is configured to generate a first conduction signal, and the second conduction circuit 102 is configured to generate a second conduction signal. Preferably, the first conduction circuit 100 is operated to prevent a high voltage value of the system power supply VDD, and the second conduction circuit 102 is operated to prevent a short initiation period of the system power supply VDD. If the first conduction circuit 100 detects the high voltage value of the system power supply VDD, the first conduction signal is generated. Also, if the second conduction circuit 102 detects the short initiation period of the system power supply VDD, the second conduction signal is generated.

The AND gate module 104 is coupled to the first conduction circuit 100 and the second conduction circuit 102 to receive the first conduction signal and the second conduction signal, so as to generate an enabling signal. The switch module 106 is realized as an n-type metal-oxide-semiconductor (MOS), which is not limiting the scope of the present invention, and comprises a first terminal coupled to the system power supply VDD, a second terminal coupled to the AND gate module 104 and a third terminal coupled to the ground GND. Under such circumstances, the power rail clamp circuit 10 is conducted if the switch module 106 is turned on by receiving the enabling signal, so as to process an electrostatic discharge operation for alleviating the electrostatic discharge (ESD) effect.

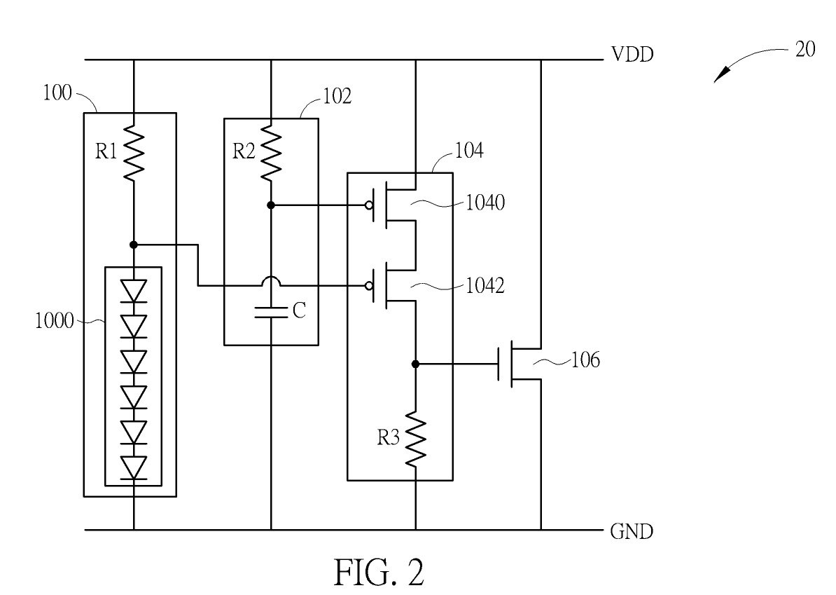

Please refer to FIG. 2, which illustrates a schematic diagram of a power rail clamp circuit 20 according to an embodiment of the present invention. The power rail clamp circuit 20 is an implementation of the power rail clamp circuit 10 shown in FIG. 1, and accordingly, the same compositions are denoted by the same symbols. In the power rail clamp circuit 20, the first conduction circuit 100 comprises a first resistor unit R1 and a conduction unit 1000, and the first resistor unit R1 and the switch unit 1000 are serially connected between the system power supply VDD and the ground GND. The second conduction circuit 102 comprises a second resistor unit R2 and a capacitor unit C, and the second resistor unit R2 and the capacitor unit C are serially connected between the system power supply VDD and the ground GND. The AND gate module 104 comprises a first p-type MOS 1040, a second p-type MOS 1042 and a third resistor unit R3. The first p-type MOS 1040 comprises a source (i.e. a first terminal) coupled to the system power supply VDD, agate (i.e. a second terminal) coupled to a node between the second resistor unit R2 and the capacitor unit C, and a drain (i.e. a third terminal). The second p-type MOS 1042 comprises a source (i.e. a first terminal) coupled to the drain of the first p-type MOS 1040, agate (i.e. a second terminal) coupled to a node between the first resistor unit R1 and the switch unit 1000, and a drain (i.e. a third terminal) coupled to the switch module 106. The third resistor unit R3 is coupled between the drain of the second p-type MOS 1042 and the ground GND.

In other words, the first conduction circuit 100 is conducted if the high voltage value of the system power supply VDD is detected (e.g. an ESD-like waveform), and accordingly, the first conduction signal turns on the second p-type MOS 1042. Also, the second conduction circuit 102 is conducted if the short initiation period of the system power supply VDD is detected (e.g. a sudden rising period 10 ns), and accordingly, the second conduction signal turns on the first p-type MOS 1040. Under such circumstances, if both the first conduction circuit 100 and the second conduction circuit 102 are conducted, the AND gate module 104 will be correspondingly turned on to conduct the switch module 106 for releasing the ESD effect. Alternatively, if one of the first conduction circuit 100 and the second conduction circuit 102 is not turned on, the AND gate module 104 and the switch module 106 will not be turned on, which can efficiently prevent an erroneously triggering and reduce a leakage while the power rail clamp circuit is operated in a normal mode (e.g. supplying with a stable voltage).

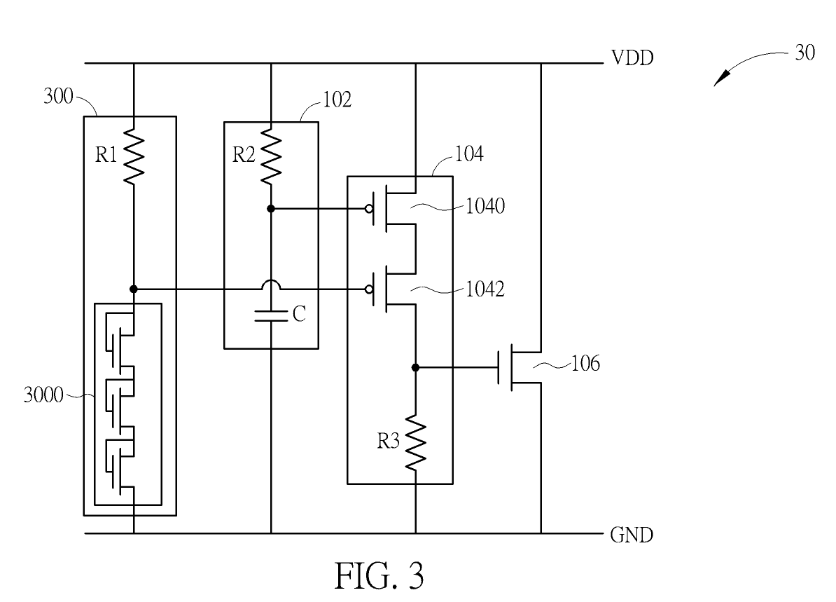

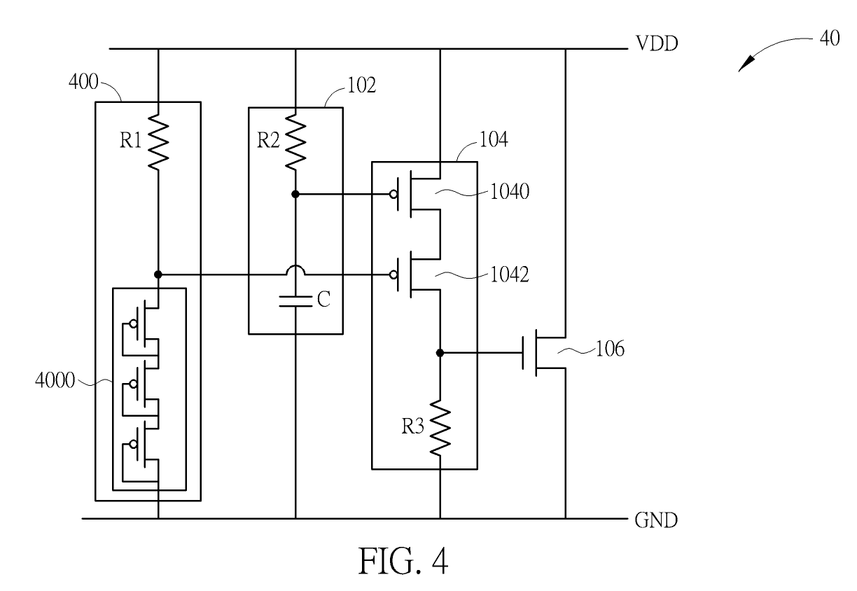

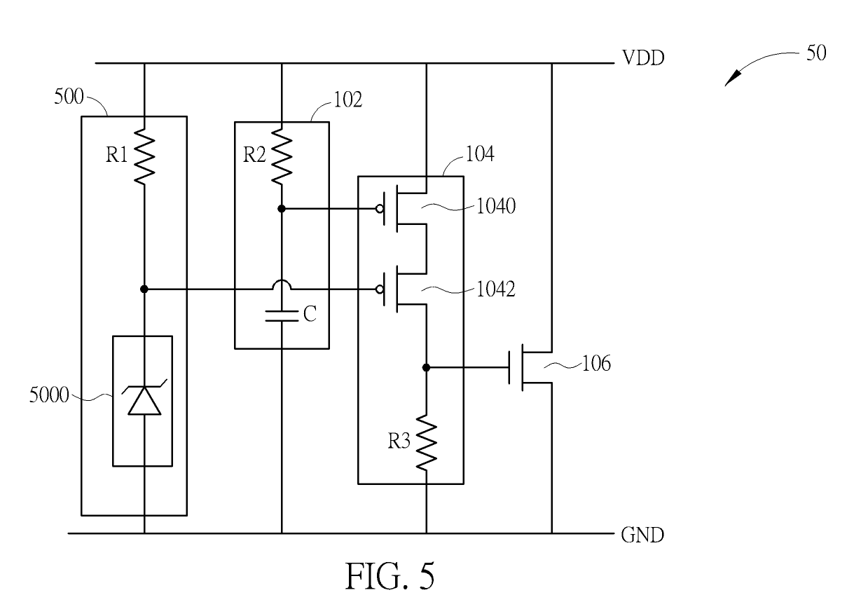

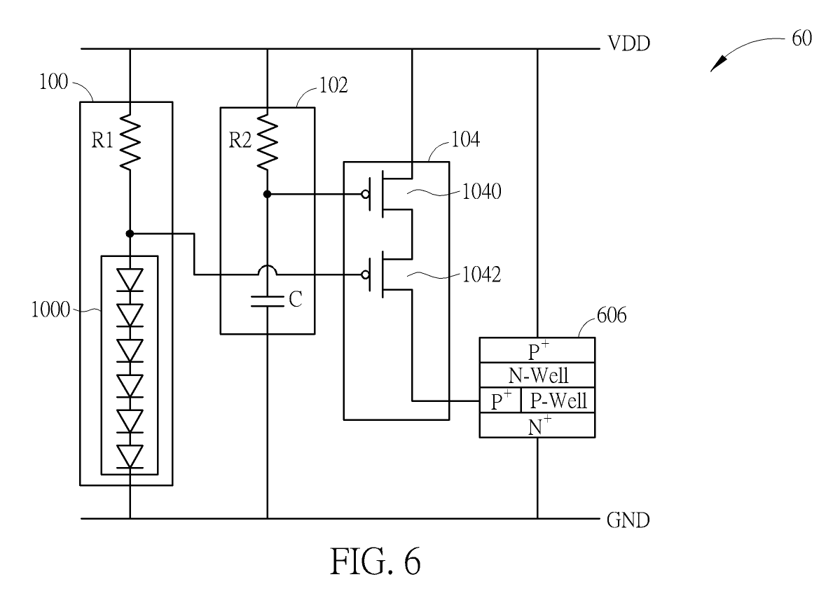

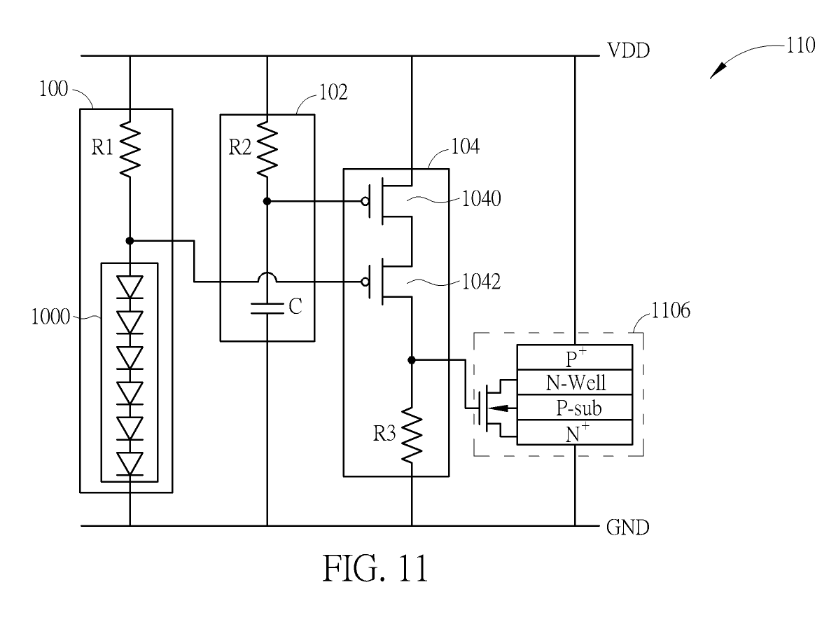

Furthermore, please refer to FIG. 3 to FIG. 6 and FIG. 11, wherein FIG. 3 to FIG. 6 and FIG. 11 illustrate schematic diagrams of power rail clamp circuits 30-60 and 110 according to embodiments of the present invention. The power rail clamp circuits 30-60 are different implementations for the power rail clamp circuit 20, and accordingly, the same compositions are denoted by the same symbols. In the power rail clamp circuit 30 shown in FIG. 3, a conduction unit 3000 of a first conduction circuit 300 is a cascaded n-type MOS unit and replaces the conduction unit 1000 of the power rail clamp circuit 20 shown in FIG. 2. In the power rail clamp circuit 40 shown in FIG. 4, a conduction unit 4000 of a first conduction circuit 400 is a cascaded p-type MOS unit and replaces the conduction unit 1000 of the power rail clamp circuit 20 shown in FIG. 2. In the power rail clamp circuit 50 shown in FIG. 5, a conduction unit 5000 of a first conduction circuit 500 is a zener diode unit and replaces the conduction unit 1000 of the power rail clamp circuit 20 shown in FIG. 2. In the power rail clamp circuit 60 shown in FIG. 6, a switch module 606 is a silicon controlled rectifier triggered by currents and replaces the switch module 106 of the power rail clamp circuit 20 shown in FIG. 2. In the power rail clamp circuit 110 shown in FIG. 11, a switch module 1106 is a silicon controlled rectifier triggered by bias and replaces the switch module 106 of the power rail clamp circuit 20 shown in FIG. 2. Note that, the switch module 606 shown in FIG. 6 and the switch module 1106 shown in FIG. 11 are both silicon controlled rectifiers, wherein the switch module 606 is a current trigger element, and the third resistor unit R3 is removed from the power rail clamp circuit 60, while the switch module 1106 is a bias trigger element, and the third resistor unit R3 is included in the power rail clamp circuit 110.

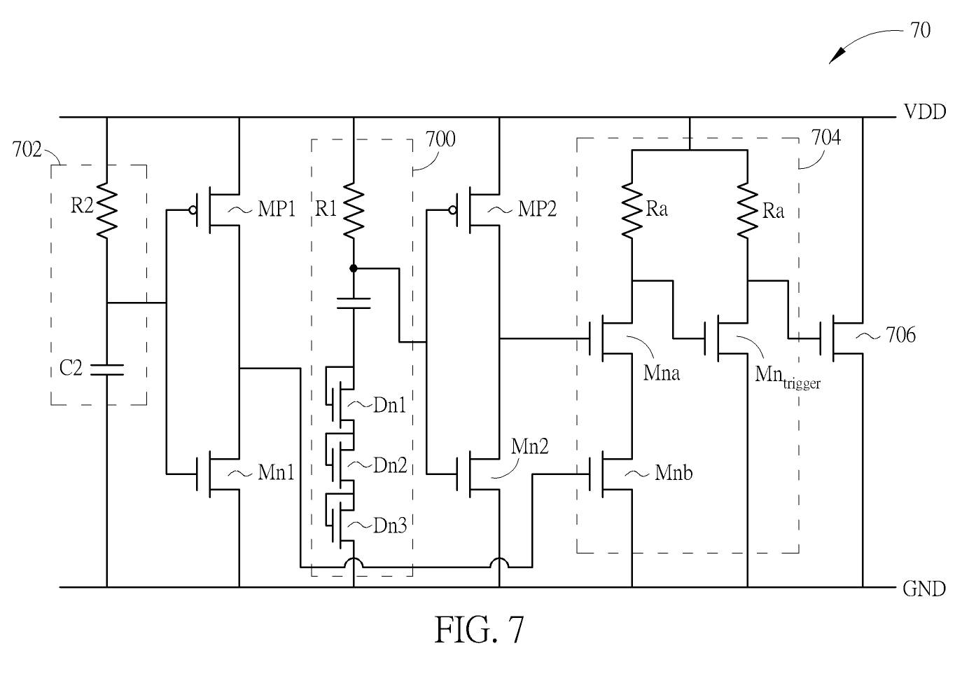

Please refer to FIG. 7, which illustrates another schematic diagram of a power rail clamp circuits 70 according to an embodiment of the present invention. In FIG. 7, the power rail clamp circuit 70 comprises a first conduction circuit 700, a second conduction circuit 702, an AND gate module 704, a switch module 706, and switch units Mp1, Mp2, Mn1, Mn2. The first conduction circuit 700, the second conduction circuit 702 and the switch module 706 are similar to the embodiments shown in FIG. 2 to FIG. 6. The main difference is that the switch units Mp1, Mn1 are cascaded to form a complementary MOS (CMOS), which is connected between the first conduction circuit 700 and the second conduction circuit 702, and the switch units Mp2, Mn2 are cascaded to form another CMOS, which is connected between the first conduction circuit 700 and the AND gate module 704. Besides, the AND gate module 704 comprises three p-type MOS' Mna, Mnb, Mn_{trigger} and two resistors Ra, so as to realize an AND function as the embodiments shown in FIG. 2 to FIG. 6.

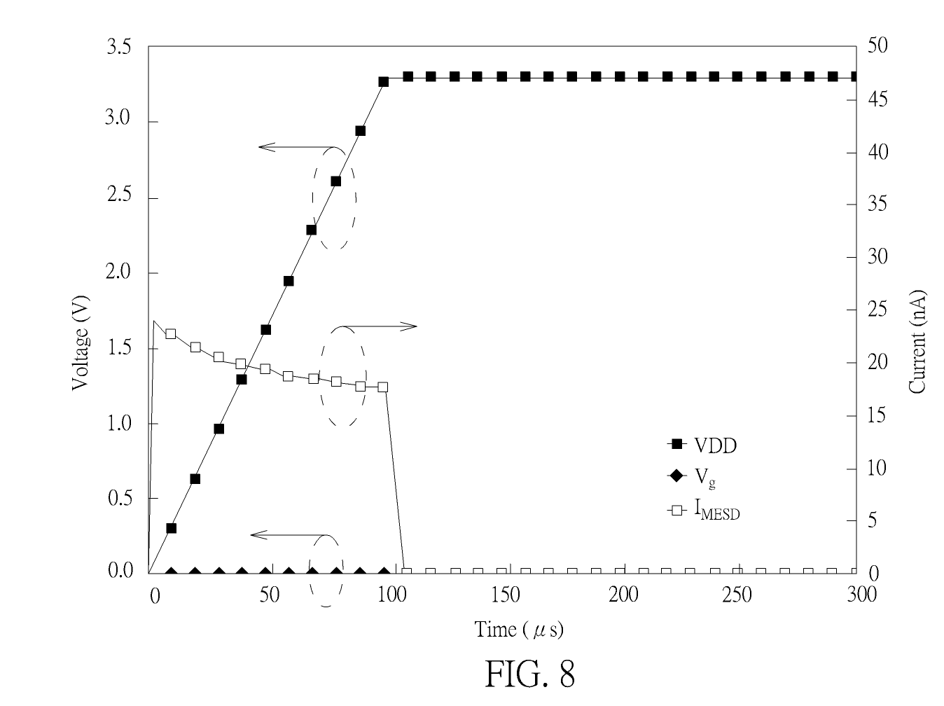

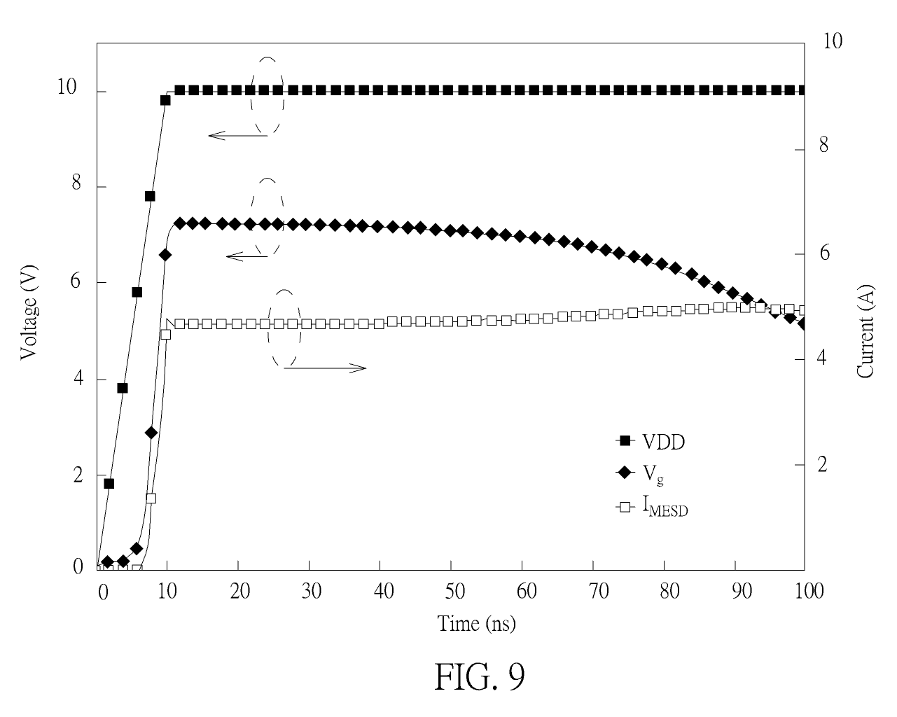

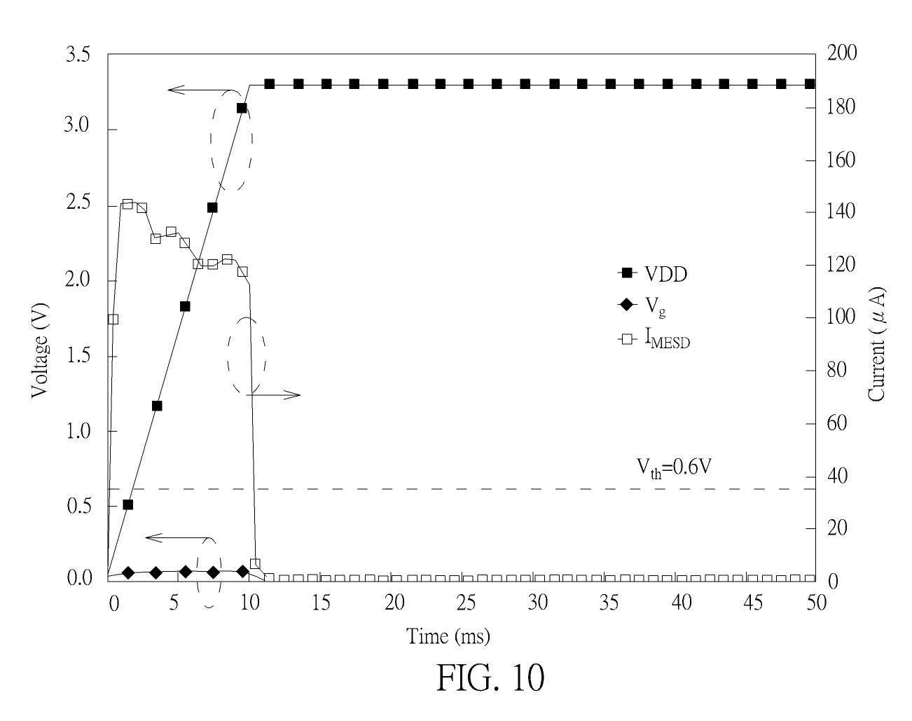

Moreover, please refer to FIG. 8 to FIG. 10, wherein FIG. 8 to FIG. 10 illustrate schematic diagrams of experimental results of the power rail clamp circuit 20. As shown in FIG. 8, the power rail clamp circuit 20 is operated in a normal power-on operation, which means a gradually increasing voltage value of the system power supply VDD is provided. As can be seen, a measured voltage value Vg of the second terminal of the switch module 106 is low and a measured current I_{MESD} passing through the switch module 106 is gone within an initiation period (e.g. 110 us). As shown in FIG. 9, the power rail clamp circuit 20 is operated under an ESD-like waveform, and accordingly, the power rail clamp circuit 20 is functionally operated to release the measured current I_{MESD} passing through the switch module 106 for efficiently alleviating the ESD effect. As shown in FIG. 10, the power rail clamp circuit 20 is operated during a fast power on condition (e.g. 10 ns), and the ESD effect is also successfully reduced with the functional operation of the power rail clamp circuit 20. Thus, the power rail clamp circuit of the embodiment can be experimentally proven to efficiently alleviate the ESD effect without generating leakage and erroneously triggering.

Noticeably, the power rail clamp circuit of the present invention includes the first conduction circuit and the second conduction circuit, so as to prevent the scenario that the system power supply has a high input voltage value or a short initiation period. Certainly, those skilled in the art can adaptively modify, adjust or combine the mentioned circuit realizations shown in FIG. 2 to FIG. 7, to achieve the same functionality with less cost and more flexible applications, which is also within the scope of the present invention.

In summary, the present invention provides the power rail clamp circuit to prevent a high voltage value of the system power supply and a short initiation period of the system power supply. Accordingly, the power rail clamp circuit can be efficiently operated to alleviate the ESD effect without being erroneously triggered or generating the leakage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power rail clamp circuit, coupled between a system power supply and a ground, the power rail clamp circuit comprising:
a first conduction circuit, coupled to the system power supply, configured to generate a first conduction signal;
a second conduction circuit, coupled to the system power supply, configured to generate a second conduction signal;
an AND gate module, coupled to the system power supply, the first conduction circuit and the second conduction circuit, configured to receive the first conduction signal and the second conduction signal for generating an enabling signal; and
a switch module, coupled to the system voltage source and the AND gate module, configured to conduct the power rail clamp circuit according to the enabling signal for processing an electrostatic discharge operation;
wherein the first conduction circuit is operated to prevent a high voltage value of the system power supply, and the second conduction circuit is operated to prevent a short initiation period of the system power supply.

2. The power rail clamp circuit of claim 1, wherein the first conduction circuit comprises a first resistor unit and a conduction unit, and the first resistor unit and the switch unit are serially connected between the system power supply and the ground.

3. The power rail clamp circuit of claim 2, wherein the conduction unit is a poly diode string unit, a cascaded p-type metal-oxide-semiconductor (MOS) unit, a cascaded n-type MOS unit, or a zener diode unit.

4. The power rail clamp circuit of claim 1, wherein the second conduction circuit comprises a second resistor unit and a capacitor unit, and the second resistor unit and the capacitor unit are serially connected between the system power supply and the ground.

5. The power rail clamp circuit of claim 1, wherein the AND gate module comprises:
a first p-type MOS, comprising a first terminal coupled to the system power supply, a second terminal coupled to the second conduction circuit, and a third terminal;
a second p-type MOS, comprising a first terminal coupled to the third terminal of the first p-type MOS, a second terminal coupled to the first conduction circuit, and a third terminal coupled to the switch module; and
a third resistor unit, coupled between the third terminal of the second p-type MOS and the ground.

6. The power rail clamp circuit of claim 5, wherein the switch module comprises a first terminal coupled to the system power supply, a second terminal coupled to the third terminal of the second p-type MOS, and a third terminal coupled to the ground.

7. The power rail clamp circuit of claim 1, wherein the switch module is an n-type MOS or a silicon controlled rectifier.
